(19) United States
(12) Patent Application Publication
(10) Pub. No.: US 2026/0343111 A1
(43) Pub. Date: Oct. 29, 2026

(54) IMAGING DEVICE

(71) Applicant: Sony Semiconductor Solutions Corporation, Kanagawa (JP)

(72) Inventor: Hiromu Kato, Kanagawa (JP)

(21) Appl. No.: 19/575,205

(22) Filed: Mar. 23, 2026

(30) Foreign Application Priority Data
Apr. 28, 2025 (JP) 2025-073995

(51) Int. Cl. H04N 25/40; H04N 25/57; H04N 25/772; H04N 25/78

(52) U.S. Cl. CPC H04N 25/40; H04N 25/57; H04N 25/772; H04N 25/78

(57) ABSTRACT

Expanding pixel signal dynamic range while suppressing a decrease in a frame rate in a global shutter operation is disclosed. In one example, an imaging device includes pixels with floating diffusions in a pixel, and sample-and-hold circuits for each of the floating diffusions.

For example, a pixel may include first and second floating diffusions, a switching transistor that switches between the first floating diffusion and the second floating diffusion, a first amplification transistor that is driven on the basis of a potential of the first floating diffusion, a second amplification transistor that is driven on the basis of a potential of the second floating diffusion, a first sample-and-hold circuit that samples and holds an output of the first amplification transistor, and a second sample-and-hold circuit that samples and holds an output of the second amplification transistor.

### CROSS REFERENCE TO RELATED APPLICATIONS

This application claims the benefit of Japanese Priority Patent Application JP 2025-073995 filed on Apr. 28, 2025, the entire contents of which are incorporated herein by reference.

### TECHNICAL FIELD

The present technology relates to an imaging device. Specifically, the present technology relates to an imaging device capable of global shutter operation.

### BACKGROUND ART

In an imaging device, there is a technology of expanding a dynamic range by switching conversion efficiency at the time of reading a signal from a pixel or reading out an overflowed charge from a photodiode. For example, a solid-state imaging device capable of holding a signal for a voltage signal corresponding to an overflow charge overflowing from a photodiode and a storage capacitor to a floating diffusion has been proposed (see, for example, PTL 1).

### CITATION LIST

### Patent Literature

### PTL 1

JP 2019-62400 A

### SUMMARY

### Technical Problem

However, in the above-described conventional technology, there has been a possibility that the number of sample-and-holds performed in time series increases in accordance with the switching of the conversion efficiency at the time of the global shutter operation, leading to a decrease in the frame rate.

The present technology has been made in view of such a situation, and it is desirable to expand a dynamic range of a pixel signal while suppressing a decrease in a frame rate in a global shutter operation.

### Solution to Problem

The present technology has been made to solve the above-described problems, and a first aspect thereof is an imaging device including a plurality of floating diffusions provided in a pixel, and a plurality of sample-and-hold circuits capable of sampling and holding a signal for each of the plurality of floating diffusions. Therefore, this brings about an effect that loss of a signal due to resetting of the floating diffusion is prevented.

Furthermore, in the first aspect, the pixel includes a photoelectric conversion section, a first floating diffusion to which charges photoelectrically converted by the photoelectric conversion section are transferred, a second floating diffusion separated from the first floating diffusion, a switching transistor that switches connection between the first floating diffusion and the second floating diffusion, a first amplification transistor that is driven on the basis of a potential of the first floating diffusion, a second amplification transistor that is driven on the basis of a potential of the second floating diffusion, a first sample-and-hold circuit that samples and holds an output of the first amplification transistor, and a second sample-and-hold circuit that samples and holds an output of the second amplification transistor. Therefore, there is an effect that the restriction between the sample-and-hold timing at the level of the first floating diffusion and the sample-and-hold timing at the level of the second floating diffusion is eliminated.

Furthermore, in the first aspect, the first sample-and-hold circuit may include a first sample-and-hold capacitor that holds charges corresponding to a P-phase HCG level, a second sample-and-hold capacitor that holds charges corresponding to a D-phase HCG level, a first sample-and-hold transistor that sets a sampling timing of the P-phase HCG level, and a second sample-and-hold transistor that sets a sampling timing of the D-phase HCG level, and the second sample-and-hold circuit may include a third sample-and-hold capacitor that holds charges corresponding to a P-phase LCG level, a fourth sample-and-hold capacitor that holds charges corresponding to the D-phase LCG level, a third sample-and-hold transistor that sets a sampling timing of the P-phase LCG level, and a fourth sample-and-hold transistor that sets the sampling timing of the D-phase LCG level. Therefore, this brings about an effect that noise is reduced on the basis of correlated double sampling (CDS) while enabling reading of the pixel signal of which conversion efficiency is switched in two stages on the basis of the global shutter operation.

Furthermore, in the first aspect, a sample-and-hold timing at the P-phase HCG level of the first sample-and-hold capacitor and a sample-and-hold timing at the P-phase LCG level of the third sample-and-hold capacitor may be equal to each other. Therefore, there is an effect that the number of sample-and-holds performed in time series according to the switching of the conversion efficiency in two stages at the time of the global shutter operation is reduced.

Furthermore, in the first aspect, there may be included a path transistor that is connected between the photoelectric conversion section and the second floating diffusion and sets a path of charges from the photoelectric conversion section. Therefore, this brings about an effect that the charges having overflowed from the photoelectric conversion section are transferred to the second floating diffusion without interposing the first floating diffusion.

Furthermore, in the first aspect, the path transistor may be turned on while the second sample-and-hold transistor is turned on in a global shutter operation period.

Therefore, this brings about an effect that the overflow charges from the photoelectric conversion section are transferred to the second floating diffusion when the charges are sampled and held in the second sample-and-hold capacitor.

Furthermore, in the first aspect, there may be included an overflow capacitor that accumulates charges having overflowed from the photoelectric conversion section.

Therefore, this brings about an effect that the dynamic range is expanded on the basis of the pixel signal on the basis of the charges overflowing from the photoelectric conversion section.

Furthermore, in the first aspect, there may be included a third sample-and-hold circuit that samples and holds an output of the first amplification transistor. Therefore, this brings about an effect that the dynamic range is expanded on the basis of the pixel signal on the basis of the charge overflowing from the photoelectric conversion section while eliminating the restriction between the sample-and-hold timing of the level of the first floating diffusion and the sample-and-hold timing of the level of the second floating diffusion.

Furthermore, in the first aspect, the first sample-and-hold circuit may include a first sample-and-hold capacitor that holds charges corresponding to a P-phase HCG level, a second sample-and-hold capacitor that holds charges corresponding to the D-phase HCG level, a first sample-and-hold transistor that sets a sampling timing of the P-phase HCG level, and a second sample-and-hold transistor that sets a sampling timing of the D-phase HCG level, the second sample-and-hold circuit may include a third sample-and-hold capacitor that holds charges corresponding to a P-phase middle conversion gain (MCG) level, a fourth sample-and-hold capacitor that holds charges corresponding to the D-phase MCG level, a third sample-and-hold transistor that sets a sampling timing of the P-phase MCG level, and a fourth sample-and-hold transistor that sets a sampling timing of the D-phase MCG level, and the third sample-and-hold circuit may include a fifth sample-and-hold capacitor that holds charges corresponding to a P-phase LCG level, a sixth sample-and-hold capacitor that holds charges corresponding to the D-phase LCG level, a fifth sample-and-hold transistor that sets a sampling timing of the P-phase LCG level, and a sixth sample-and-hold transistor that sets the sampling timing of the D-phase LCG level. Therefore, this brings about an effect that noise is reduced on the basis of CDS while enabling reading of the pixel signal of which conversion efficiency is switched in three stages on the basis of the global shutter operation.

Furthermore, in the first aspect, a sample-and-hold timing at the P-phase HCG level of the first sample-and-hold capacitor and a sample-and-hold timing at the P-phase MCG level of the third sample-and-hold capacitor may be equal to each other. Therefore, there is an effect that the number of sample-and-holds performed in time series according to the switching of the conversion efficiency in three stages at the time of the global shutter operation is reduced.

Furthermore, in the first aspect, there may be included a pixel array section in which the pixels are arranged in a matrix in a row direction and a column direction, a read circuit that reads out a pixel signal sampled and held in the pixel in the column direction, and an AD conversion section that performs AD conversion on the pixel signal read by the read circuit. Therefore, this brings about an effect that an image with an expanded dynamic range is acquired for each frame while suppressing a decrease in the frame rate based on the global shutter operation.

### BRIEF DESCRIPTION OF DRAWINGS

FIG. 1 is a block diagram illustrating a configuration example of an imaging device according to a first embodiment.

FIG. 2 is a block diagram illustrating a configuration example of a solid-state imaging device according to the first embodiment.

FIG. 3 is a diagram illustrating a circuit configuration example of a pixel provided in the solid-state imaging device according to the first embodiment.

FIG. 4 is a timing chart indicating an exemplary waveform of each part during read from a pixel according to the first embodiment.

FIG. 5 is a diagram illustrating a circuit configuration example of a pixel provided in a solid-state imaging device according to a second embodiment.

FIG. 6 is a timing chart indicating an exemplary waveform of each part during read from a pixel according to the second embodiment.

FIG. 7 is a diagram illustrating a circuit configuration example of a pixel provided in a solid-state imaging device according to a third embodiment.

FIG. 8 is a timing chart indicating an exemplary waveform of each part during read from a pixel according to the third embodiment.

FIG. 9 is a diagram illustrating a circuit configuration example of a pixel provided in a solid-state imaging device according to a fourth embodiment.

FIG. 10 is a timing chart indicating an exemplary waveform of each part during read from a pixel according to the fourth embodiment.

FIG. 11 is a perspective view illustrating an example of stacking of a solid-state imaging device according to a fifth embodiment.

FIG. 12 is a block diagram illustrating a schematic configuration example of a vehicle control system.

FIG. 13 is an explanatory diagram illustrating an example of installation positions of an imaging section.

### DESCRIPTION OF EMBODIMENTS

Hereinafter, modes for carrying out the present technology (hereinafter referred to as embodiments) will be described.

The description will be given in the following order.
1. First embodiment (Example in which a sample-and-hold circuit is provided for each of two floating diffusions provided in a pixel, and two series circuits of a sample-and-hold capacitor and a sample-and-hold transistor are connected in parallel between a source of an amplification transistor and the floating diffusion)
2. Second embodiment (Example in which a sample-and-hold circuit is provided for each of two floating diffusions provided in a pixel, and a path transistor for setting a path of a charge from a photodiode is provided)
3. Third Embodiment (Example in which a sample-and-hold circuit is provided for each of two floating diffusions provided in a pixel, and one floating diffusion is shared by the two sample-and-hold circuits)
4. Fourth Embodiment (Example in which a sample-and-hold circuit is provided for each of two floating diffusions provided in a pixel, and two series circuits of a sample-and-hold capacitor and a sample-and-hold transistor are connected in parallel between the floating diffusion and a ground potential)
5. Fifth Embodiment (Example of stacked pixel array section)
6. Application example to mobile body

### 1. First Embodiment

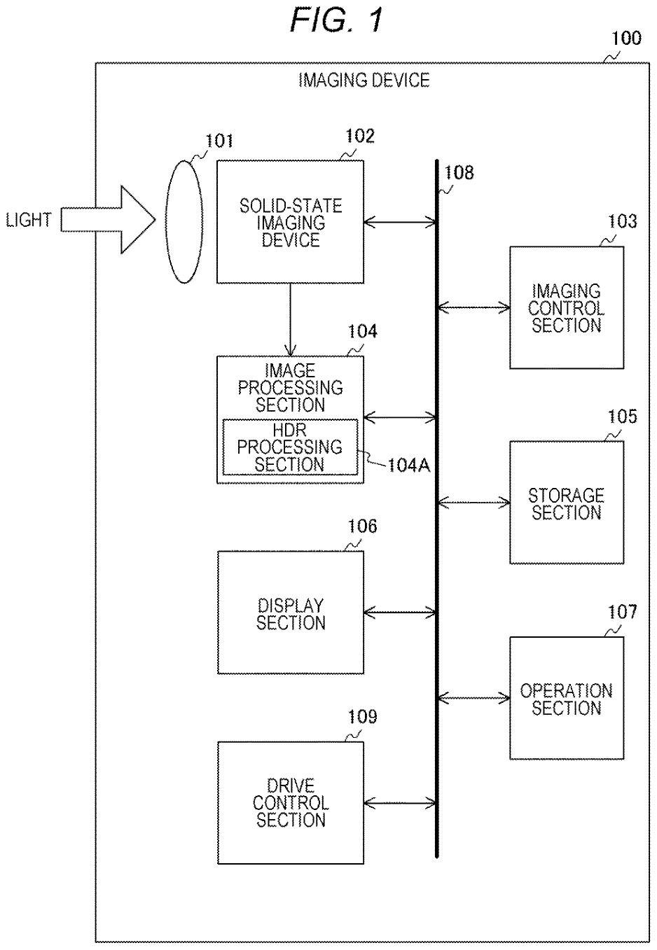

FIG. 1 is a block diagram illustrating a configuration example of an imaging device according to a first embodiment.

In the drawing, an imaging device 100 includes an optical system 101, a solid-state imaging device 102, an imaging control section 103, an image processing section 104, a storage section 105, a display section 106, and an operation section 107. Furthermore, the imaging device 100 includes a drive control section 109. The imaging control section 103, the image processing section 104, the storage section 105, the display section 106, the operation section 107, and the drive control section 109 are connected to one another via a bus 108. Note that the imaging device 100 may be used alone, may be incorporated in a mobile terminal such as a smartphone, may be incorporated in an authentication device or a monitoring device, or may be incorporated in a vehicle or a drone.

The optical system 101 causes light from a subject to enter the solid-state imaging device 102, and forms an optical image on a light-receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts light from the optical image formed on the light-receiving surface into an electric signal for each pixel, and digitizes and outputs the electric signal. At this time, the solid-state imaging device 102 can output the pixel signal by switching the conversion efficiency of the pixel. For example, the solid-state imaging device 102 may switch the conversion efficiency of the pixel in two stages or in three stages. Furthermore, the solid-state imaging device 102 can include a plurality of floating diffusions to which charges are transferred from the pixels.

Furthermore, the solid-state imaging device 102 may include a Lateral Overflow Integration Capacitor (LOFIC). The solid-state imaging device 102 is, for example, a complementary metal oxide semiconductor (CMOS) image sensor. The CMOS image sensor may be a back-illuminated image sensor or a front-illuminated image sensor.

The imaging control section 103 controls the imaging by the solid-state imaging device 102 on the basis of a command from the operation section 107. At this time, the imaging control section 103 can control the exposure time, the exposure amount, the imaging timing, and the like of the solid-state imaging device 102.

The image processing section 104 performs image processing on the basis of the output from the solid-state imaging device 102.

The image processing is, for example, gamma correction, white balance processing, sharpness processing, or gradation conversion processing. The image processing section 104 may include a processor that executes processing on the basis of software. The image processing section 104 includes a high dynamic range (HDR) processing section 104A.

The HDR processing section 104A performs HDR processing on the basis of the pixel signal read from the solid-state imaging device 102. For example, the HDR processing section 104A may generate an HDR image on the basis of a combination of a high conversion gain (HCG) output and a low conversion gain (LCG) output generated by the solid-state imaging device 102. Furthermore, the HDR processing section 104A may generate an HDR image on the basis of a combination of an HCG output, a middle conversion gain (MCG) output, and an LCG output generated by the solid-state imaging device 102.

The storage section 105 stores a captured image captured by the solid-state imaging device 102, and stores imaging parameters and the like of the solid-state imaging device 102. Furthermore, the storage section 105 can store a program for operating the imaging device 100 on the basis of software. The storage section 105 may include a read only memory (ROM), a random access memory (RAM), and a memory card.

The display section 106 displays a captured image and displays various types of information supporting the imaging operation. The display section 106 may be a liquid crystal display, an organic electro luminescence (EL) display, or a micro LED display.

The operation section 107 provides a user interface for operating the imaging device 100. The operation section 107 may include, for example, a button, a dial, and a switch provided in the imaging device 100. The operation section 107 may be configured as a touch panel configured together with the display section 106.

The drive control section 109 controls driving of the optical system 101 on the basis of the pixel signal read from the solid-state imaging device 102 and the operation information operated by the operation section 107. For example, the drive control section 109 can perform manual focusing or control zoom magnification on the basis of operation information operated by the operation section 107.

Note that depending on the form of the imaging device 100, some of the above-described functions may be omitted, or conversely, functions that are not disclosed may be further included.

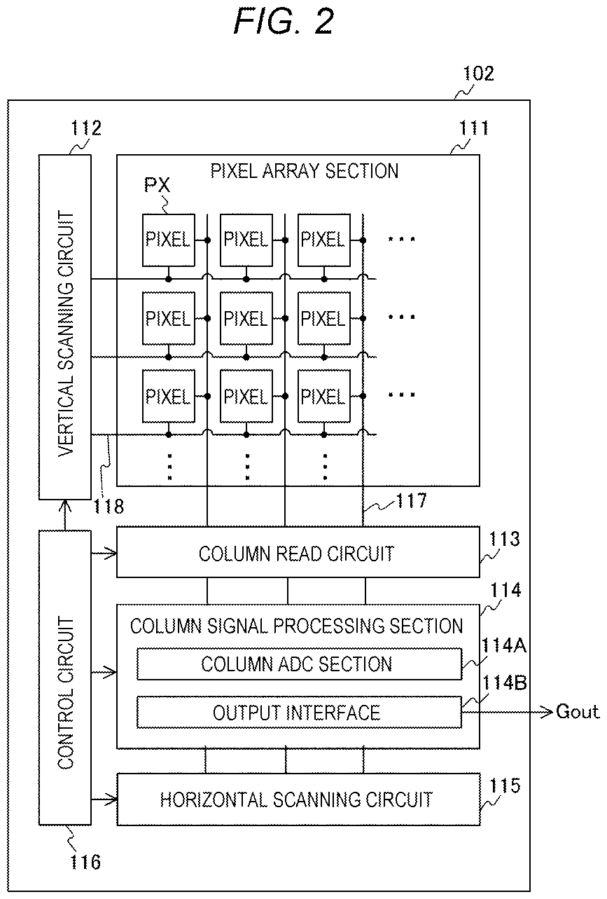

FIG. 2 is a block diagram illustrating a configuration example of the solid-state imaging device according to the first embodiment.

In FIG. 2, the solid-state imaging device 102 includes a pixel array section 111, a vertical scanning circuit 112, a column read circuit 113, a column signal processing section 114, a horizontal scanning circuit 115, and a control circuit 116.

The pixel array section 111 includes a plurality of pixels PX. These pixels PX are arranged in a matrix along a row direction (also referred to as a horizontal direction) and the column direction (also referred to as a vertical direction). Each pixel PX may generate a plurality of read levels on the basis of switching of conversion efficiency.

Each pixel PX may include a capacitor that accumulates charges overflowing from the photodiode. The capacitor may be a LOFIC. Each pixel PX may include a plurality of photodiodes having different sensitivities. Each pixel PX can include a plurality of floating diffusions and a sample-and-hold circuit capable of sampling and holding a signal for each floating diffusion. At this time, on the basis of the rolling shutter operation, each pixel PX can read the pixel signal sampled and held on the basis of the global shutter operation. Each pixel PX can form a source follower with the column read circuit 113 during signal read.

Each pixel PX is connected to a horizontal drive line 118 for each row, and is connected to a vertical signal line 117 for each column. When reading a signal from each pixel PX, the horizontal drive line 118 drives the pixels PX for each row. The vertical signal line 117 transmits potentials based on currents flowing at the time of signal reading from each pixel PX to the column signal processing section 114 for each column.

Each pixel PX may be arranged in a Bayer pattern or a Quad Bayer pattern. The light received by each pixel PX may be visible light, near infrared light (NIR), short wavelength infrared light (SWIR), ultraviolet light, X-rays, or the like.

The vertical scanning circuit 112 scans the pixels PX to be read in the column direction. The vertical scanning circuit 112 may be configured using a vertical register. The vertical scanning circuit 112 may include a decoder that designates the pixel PX to be read.

The column read circuit 113 can form a source follower with each pixel PX at the time of reading out a signal from each pixel PX. At this time, the column read circuit 113 can change each potential of the vertical signal line 117 on the basis of the charges held in each pixel PX.

The column signal processing section 114 processes a signal transmitted from each pixel PX in the column direction.

For example, the column signal processing section 114 can perform correlated double sampling (CDS) processing on the basis of the signal transmitted from each pixel PX in the column direction. Furthermore, the column signal processing section 114 can perform analog to digital (AD) conversion processing on the basis of the signal transmitted from each pixel PX in the column direction and output an imaging signal Gout.

The column signal processing section 114 includes a column ADC section 114A and an output interface 114B. The column ADC section 114A can parallelly perform AD conversion processing on the column basis. At this time, the column ADC section 114A can perform AD conversion for each column on the basis of a comparison result between a pixel signal read from each pixel PX and a reference signal. The output interface 114B outputs an imaging signal Gout processed by the column signal processing section 114. The imaging signal Gout may include an HCG output and an LCG output, or may include an HCG output, an MCG output, and an LCG output. The output interface 114B may correspond to a mobile industry processor interface (MIPI), scalable low voltage signaling (SLVS), low voltage differential signaling (LVDS), or the like. The horizontal scanning circuit 115 scans the pixel PX to be read in the row direction. The horizontal scanning circuit 115 may be configured using a horizontal register.

The control circuit 116 controls the vertical scanning circuit 112, the column read circuit 113, the column signal processing section 114, and the horizontal scanning circuit 115. For example, the control circuit 116 can control the scanning timing in the column direction, the scanning timing in the row direction, the operation timing of the column read circuit 113, and the processing timing of the column signal processing section 114. At this time, the control circuit 116 can cause the vertical scanning circuit 112, the column read circuit 113, the column signal processing section 114, and the horizontal scanning circuit 115 to cooperate so that the image frame is read on the basis of the global shutter operation and the rolling shutter operation.

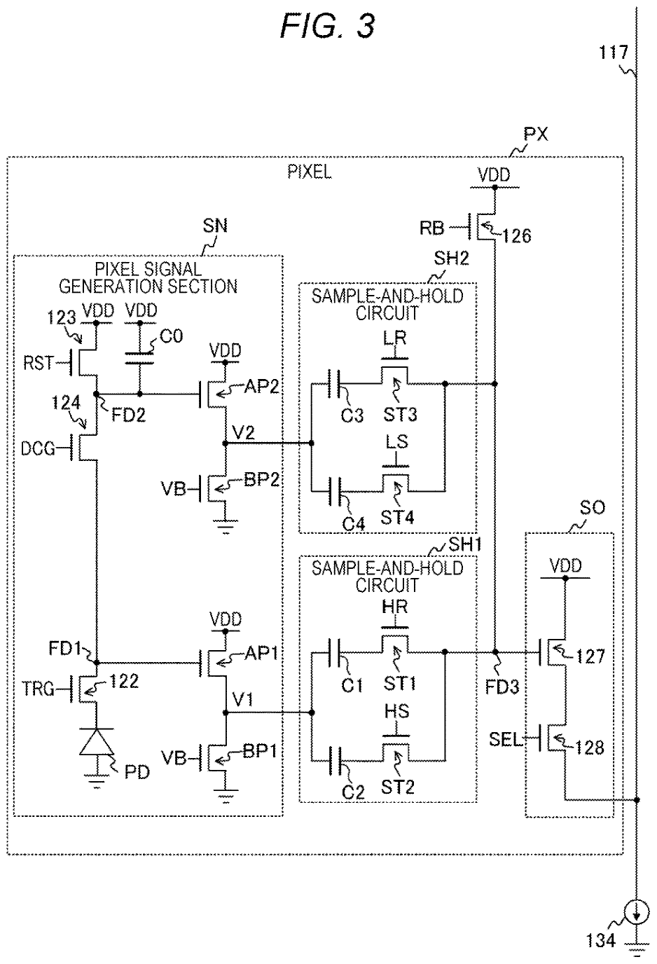

FIG. 3 is a diagram illustrating a circuit configuration example of the pixel provided in the solid-state imaging device according to the first embodiment.

In the drawing, the pixel PX can sample and hold a pixel signal on the basis of a global shutter operation and output the sampled and held pixel signal. The pixel signal can include a P-phase level (also referred to as a reset level) and a D-phase level (also referred to as a data level) signal. At this time, the P-phase level and the D-phase level can each include a plurality of levels having different conversion efficiencies.

The pixel PX includes a pixel signal generation section SN, sample-and-hold circuits SH1 and SH2, and an output circuit SO. Each of the sample-and-hold circuits SH1 and SH2 is connected to a subsequent stage of the pixel signal generation section SN. The output circuit so is connected to a subsequent stage of each of the sample-and-hold circuits SH1 and SH2. The pixel signal generation section SN generates a pixel signal on the basis of photoelectric conversion. Each of the sample-and-hold circuits SH1 and SH2 samples and holds the pixel signal generated by the pixel signal generation section SN. The output circuit SO outputs the pixel signal sampled and held by each of the sample-and-hold circuits SH1 and SH2.

The pixel signal generation section SN includes a photodiode PD, a transfer transistor 122, a reset transistor 123, a switching transistor 124, amplification transistors AP1 and AP2, and current source transistors BP1 and BP2. Furthermore, the pixel signal generation section SN includes a plurality of floating diffusions FD1 and FD2. The floating diffusions FD1 and FD2 can be separated from each other. The pixel signal generation section SN may include a capacitor C0. The capacitor C0 may not be provided. At this time, the parasitic capacitance of the floating diffusion FD2 may be used instead of the capacitor C0. The sample-and-hold circuit SH1 includes sample-and-hold capacitors C1 and C2 and sample-and-hold transistors ST1 and ST2. The sample-and-hold circuit SH2 includes sample-and-hold capacitors C3 and C4 and sample-and-hold transistors ST3 and ST4. The sample-and-hold circuits SH1 and SH2 are provided for the floating diffusions FD1 and FD2, respectively. The output circuit so includes an amplification transistor 127 and a selection transistor 128.

The photodiode PD performs photoelectric conversion and accumulates the photoelectrically converted charge. The transfer transistor 122 transfers charges accumulated in the photodiode PD to the floating diffusion FD1. The reset transistor 123 resets the photodiode PD and the floating diffusion FD1. The switching transistor 124 switches connection between the floating diffusions FD1 and FD2. The amplification transistor AP1 outputs a signal according to the potential of the floating diffusion FD1. The amplification transistor AP2 outputs a signal according to the potential of the floating diffusion FD2. The current source transistor BP1 sets a current flowing through the amplification transistor AP1. The current source transistor BP2 sets a current flowing through the amplification transistor AP2. A reset transistor 126 resets a floating diffusion FD3. The amplification transistor 127 outputs a signal according to the potential of the floating diffusion FD3. The selection transistor 128 selects the output of the amplification transistor 127.

The sample-and-hold circuit SH1 samples and holds the pixel signal output from the amplification transistor AP1. At this time, the sample-and-hold circuit SH1 can sample and hold the pixel signal on the basis of the global shutter operation. The sample-and-hold capacitor C1 samples and holds the P-phase level output from the amplification transistor AP1.

The sample-and-hold capacitor C2 samples and holds the D-phase level output from the amplification transistor AP1. The sample-and-hold transistor ST1 sets the sampling timing of the P-phase level output from the amplification transistor AP1. The sample-and-hold transistor ST2 sets the sampling timing of the D-phase level output from the amplification transistor AP1.

The sample-and-hold circuit SH2 samples and holds the pixel signal output from the amplification transistor AP2. At this time, the sample-and-hold circuit SH2 can sample and hold the pixel signal on the basis of the global shutter operation. The sample-and-hold capacitor C3 samples and holds the P-phase level output from the amplification transistor AP2.

The sample-and-hold capacitor C4 samples and holds the D-phase level output from the amplification transistor AP2. The sample-and-hold transistor ST3 sets the sampling timing of the P-phase level output from the amplification transistor AP2. The sample-and-hold transistor ST4 sets the sampling timing of the D-phase level output from the amplification transistor AP2.

The current source transistor BP1 forms a source follower with the amplification transistor AP1. The current source transistor BP2 forms a source follower with the amplification transistor AP2. A current source 134 forms a source follower with the amplification transistor 127. The transfer transistor 122 is connected between the cathode of the photodiode PD and the floating diffusion FD1. The reset transistor 123 is connected between a power supply potential VDD and the switching transistor 124. The switching transistor 124 is connected between the reset transistor 123 and the floating diffusion FD1. The capacitor C0 is connected between the connection point between the reset transistor 123 and the switching transistor 124 and the power supply potential VDD. The capacitor Co can be used to set conversion efficiency in the amplification transistor AP2. The gate of the amplification transistor AP1 is connected to the floating diffusion FD1. The gate of the amplification transistor AP2 is connected to the floating diffusion FD2. The amplification transistor AP1 and the current source transistor BP1 are connected in series to each other. The amplification transistor AP2 and the current source transistor BP2 are connected in series to each other. The amplification transistor 127 and the selection transistor 128 are connected in series.

The drain of the amplification transistor 127 is connected to the power supply potential VDD. The gate of the amplification transistor 127 is connected to the floating diffusion FD3. The source of the selection transistor 128 is connected to the vertical signal line 117. The reset transistor 126 is connected between the floating diffusion FD3 and the power supply potential VDD.

The sample-and-hold circuit SH1 is connected between the source of the amplification transistor AP1 and the floating diffusion FD3. The sample-and-hold capacitor C1 and the sample-and-hold transistor ST1 are connected in series to each other. The sample-and-hold capacitor C2 and the sample-and-hold transistor ST2 are connected in series to each other. These series circuits are connected in parallel between the source of the amplification transistor AP1 and the floating diffusion FD3.

The sample-and-hold circuit SH2 is connected between the source of the amplification transistor AP2 and the floating diffusion FD3. The sample-and-hold capacitor C3 and the sample-and-hold transistor ST3 are connected in series to each other. The sample-and-hold capacitor C4 and the sample-and-hold transistor ST4 are connected in series to each other. These series circuits are connected in parallel between the source of the amplification transistor AP2 and the floating diffusion FD3.

The transfer transistor 122, the reset transistors 123 and 126, the switching transistor 124, the amplification transistors AP1, AP2, and 127, the current source transistors BP1 and BP2, the selection transistor 128, and the sample-and-hold transistors ST1 to ST4 may be metal oxide semiconductor (MOS) transistors.

A transfer signal TRG is applied to the gate of the transfer transistor 122. The reset signal RST is applied to the gate of the reset transistor 123. A switching signal DCG is applied to the gate of the switching transistor 124. A reset signal RB is applied to the gate of the reset transistor 126. A selection signal SEL is applied to the gate of the selection transistor 128. A sample-and-hold signal HR is applied to the gate of the sample-and-hold transistor ST1. A sample-and-hold signal HS is applied to the gate of the sample-and-hold transistor ST2. A sample-and-hold signal LR is applied to the gate of the sample-and-hold transistor ST3. A sample-and-hold signal LS is applied to the gate of the sample-and-hold transistor ST4. The transfer signal TRG, the reset signals RST and RB, the selection signal SEL, the switching signal DCG, and the sample-and-hold signals HR, HS, LR, and LS can be transmitted to the pixel PX via the horizontal drive line 118 in FIG. 2.

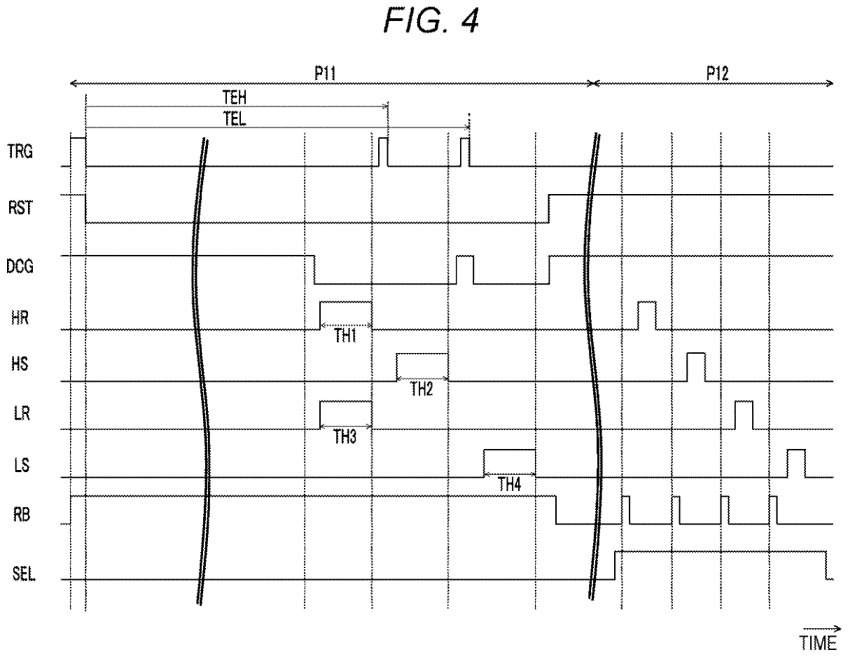

FIG. 4 is a timing chart indicating an exemplary waveform of each part during read from a pixel according to the first embodiment.

In the drawing, in reading the pixel signal from the pixel PX, a global shutter operation period P11 and a rolling shutter operation period P12 are provided for each frame. In the global shutter operation period P11, the P-phase HCG level and the D-phase HCG level of all the pixels PX of the pixel array section 111 are sampled and held in the sample-and-hold capacitors C1 and C2, respectively, on the basis of the global shutter operation. Furthermore, in the global shutter operation period P11, the P-phase LCG level and the D-phase LCG level of all the pixels PX of the pixel array section 111 are sampled and held in the sample-and-hold capacitors C3 and C4, respectively, on the basis of the global shutter operation. At this time, the sample and hold of the P-phase HCG level and the P-phase LCG level of all the pixels PX of the pixel array section 111 can be performed simultaneously.

In the rolling shutter operation period P12, the P-phase HCG level and the D-phase HCG level sampled and held in the sample-and-hold capacitors C1 and C2, respectively, are read through the vertical signal line 117 for each row on the basis of the rolling shutter operation. Then, in the column ADC section 114A, the P-phase HCG level and the D-phase HCG level are each AD-converted, and CDS processing is performed. Furthermore, in the rolling shutter operation period P12, the P-phase LCG level and the D-phase LCG level sampled and held in the sample-and-hold capacitors C3 and C4, respectively, are read through the vertical signal line 117 for each row on the basis of the rolling shutter operation. Then, the column ADC section 114A performs AD conversion on each of the P-phase LCG level and the D-phase LCG level, and performs CDS processing.

Specifically, in the global shutter operation period P11, the transfer signal TRG, the switching signal DCG, and the reset signal RST rise before exposure starts. At this time, the transfer transistors 122, the reset transistors 123, and the switching transistors 124 of all the pixels PX are turned on, and the charges of the photodiodes PD and the floating diffusions FD1 and FD2 are discharged. Furthermore, the reset signal RB rises, and the reset transistor 126 is turned on. At this time, the floating diffusion FD3 is connected to the power supply potential VDD via the reset transistor 126. Then, the transfer signal TRG and the reset signal RST fall. At this time, the transfer transistor 122 and the reset transistor 123 are turned off, and the exposure period is started.

Next, the switching signal DCG falls, and the switching transistor 124 is turned off. At this time, the floating diffusions FD1 and FD2 are separated from each other, and the source potentials V1 and V2 of the amplification transistors AP1 and AP2 change according to the potentials of the floating diffusions FD1 and FD2, respectively. Thereafter, the sample-and-hold signals HR and LR rise, and the sample-and-hold transistors ST1 and ST3 are turned on. At this time, charges corresponding to the source potentials V1 and V2 of the amplification transistors AP1 and AP2 are accumulated in the sample-and-hold capacitors C1 and C3, respectively. Here, the P-phase HCG level is held in the sample-and-hold capacitor C1, and the P-phase LCG level is held in the sample-and-hold capacitor C3. Then, the sample-and-hold signals HR and LR fall, and the sample-and-hold transistors ST1 and ST3 are turned off. At this time, the charging times of the sample-and-hold capacitors C1 and C3 are set to TH1 and TH3. The charging times TH1 and TH3 of the sample-and-hold capacitors C1 and C3 may be different from each other. Here, the minimum exposure time can be set to a larger one of the charging times TH1 and TH3.

Next, the transfer signal TRG rises, and the transfer transistors 122 of all the pixels PX are turned on. At this time, charges that are accumulated in the photodiode PD are transferred to the floating diffusion FD1. Then, the transfer signal TRG falls, and the transfer transistors 122 of all the pixels PX are turned off. At this time, the exposure time at the D-phase HCG level is set to TEH.

Next, the sample-and-hold signal HS rises, and the sample-and-hold transistor ST2 is turned on. At this time, charges corresponding to the source potential V1 of the amplification transistor AP1 are accumulated in the sample-and-hold capacitor C2. Here, the D-phase HCG level is held in the sample-and-hold capacitor C2. Then, the sample-and-hold signal HS falls, and the sample-and-hold transistor ST2 is turned off. At this time, the charging time of the sample-and-hold capacitor C2 is set to TH2.

Next, the switching signal DCG rises, and the switching transistor 124 is turned on. At this time, the floating diffusions FD1 and FD2 are connected to each other. Then, the transfer signal TRG rises, and the transfer transistors 122 of all the pixels PX are turned on. At this time, charges that are accumulated in the photodiode PD are transferred to the floating diffusions FD1 and FD2. Then, the transfer signal TRG falls, and the transfer transistors 122 of all the pixels PX are turned off. At this time, the exposure time of the D-phase LCG level is set to TEL. Here, the difference between the exposure time TEH at the D-phase HCG level and the exposure time TEL at the D-phase LCG level is set according to the charging time TH2 of the sample-and-hold capacitor C2.

Next, the switching signal DCG falls, and the switching transistor 124 is turned off. At this time, the floating diffusions FD1 and FD2 are separated from each other, and the source potentials V1 and V2 of the amplification transistors AP1 and AP2 change according to the potentials of the floating diffusions FD1 and FD2, respectively.

Next, the sample-and-hold signal LS rises, and the sample-and-hold transistor ST4 is turned on. At this time, charges corresponding to the source potential V2 of the amplification transistor AP2 are accumulated in the sample-and-hold capacitor C4. Here, the D-phase LCG level is held in the sample-and-hold capacitor C4. Then, the sample-and-hold signal LS falls, and the sample-and-hold transistor ST4 is turned off. At this time, the charging time of the sample-and-hold capacitor C4 is set to TH4.

Next, the switching signal DCG and the reset signal RST rise. At this time, the reset transistor 123 and the switching transistor 124 of all the pixels PX are turned on, and the charges of the floating diffusions FD1 and FD2 are discharged. Then, the reset signal RB falls, and the reset transistor 126 is turned off.

Next, in the rolling shutter operation period P12, the selection signal SEL rises. At this time, the selection transistor 128 is turned on, and the amplification transistor 127 is connected to the vertical signal line 117.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal HR rises, and the sample-and-hold transistor ST1 is turned on. At this time, the charges accumulated in the sample-and-hold capacitor C1 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the P-phase HCG level is read for each row on the basis of the source follower operation with the current source 134.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal HS rises, and the sample-and-hold transistor ST2 is turned on. At this time, the charges accumulated in the sample-and-hold capacitor C2 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the D-phase HCG level is read for each row on the basis of the source follower operation with the current source 134. At this time, by performing the CDS processing on the basis of the P-phase HCG level and the D-phase HCG level, the dark current component included in the D-phase HCG level can be canceled, and the signal noise ratio (SNR) of the D-phase HCG level can be improved.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal LR rises, and the sample-and-hold transistor ST3 is turned on. At this time, the charges accumulated in the sample-and-hold capacitor C3 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the P-phase LCG level is read for each row on the basis of the source follower operation with the current source 134.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal LS rises, and the sample-and-hold transistor ST4 is turned on. At this time, the charges accumulated in the sample-and-hold capacitor C4 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the D-phase LCG level is read for each row on the basis of the source follower operation with the current source 134. At this time, by performing the CDS processing on the basis of the P-phase LCG level and the D-phase LCG level, the dark current component included in the D-phase LCG level can be canceled, and the SNR of the D-phase LCG level can be improved.

As described above, in the first embodiment described above, the sample-and-hold circuits SH1 and SH2 are provided for the floating diffusions FD1 and FD2 of the pixel PX, and the amplification transistors AP1 and AP2 are provided for the sample-and-hold circuits SH1 and SH2. Therefore, the P-phase LCG level can be sampled and held before the D-phase LCG level is sampled and held.

Therefore, the dark current component included in the D-phase LCG level can be canceled on the basis of the P-phase LCG level, and the SNR step between the D-phase HCG level and the D-phase LCG level can be eliminated while suppressing the decrease in the gain difference between the D-phase HCG level and the D-phase LCG level.

Therefore, it is possible to expand the dynamic range while suppressing the degradation of the image quality at the time of the global shutter operation.

Furthermore, it is possible to simultaneously hold samples of the P-phase HCG level and the P-phase LCG level. Therefore, the number of sample-and-holds performed in time series in accordance with the switching of the conversion efficiency at the time of the global shutter operation can be reduced from four to three, and a decrease in the frame rate in HDR can be suppressed.

### 2. Second Embodiment

In the first embodiment described above, the sample-and-hold circuits SH1 and SH2 have been provided for the floating diffusions FD1 and FD2 of the pixel PX, and the amplification transistors AP1 and AP2 have been provided for the sample-and-hold circuits SH1 and SH2. In the second embodiment, the sample-and-hold circuits SH1 and SH2 are provided for the floating diffusions FD1 and FD2 of the pixel PX, the amplification transistors AP1 and AP2 are provided for the sample-and-hold circuits SH1 and SH2, and a path transistor for setting a path of charges from the photodiode PD to the floating diffusion FD2 is provided.

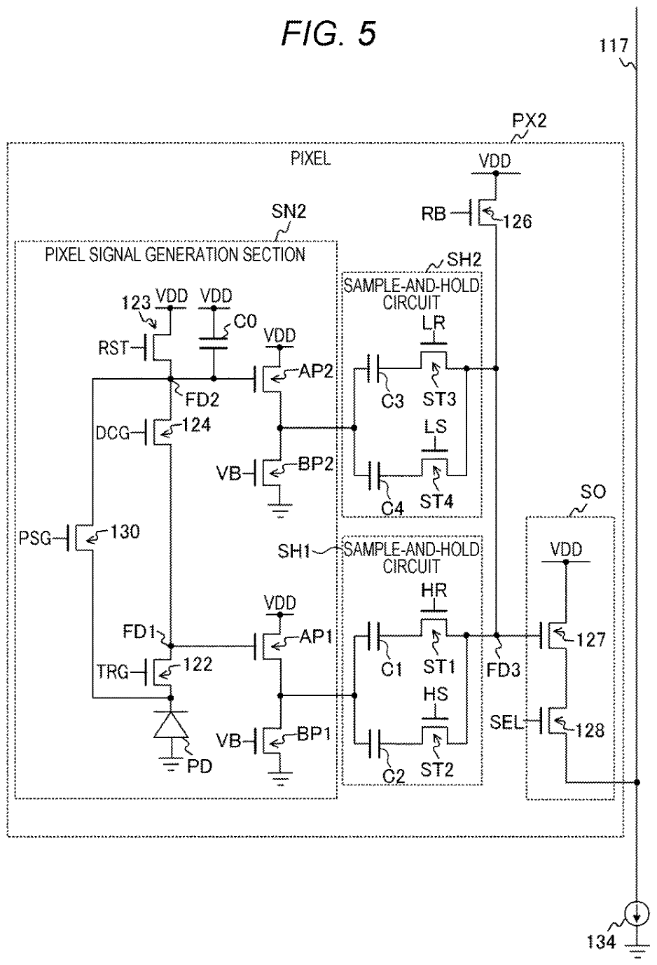

FIG. 5 is a diagram illustrating a circuit configuration example of the pixel provided in the solid-state imaging device according to the second embodiment.

In the drawing, the pixel PX2 includes a pixel signal generation section SN2 instead of the pixel signal generation section SN of the first embodiment described above. The other configurations of the pixel PX2 are similar to the configurations of the pixel PX of the first embodiment described above.

In the pixel signal generation section SN2, a path transistor 130 is added to the pixel signal generation section SN of the above-described first embodiment. The other configurations of the pixel signal generation section SN2 are similar to the configurations of the pixel signal generation section SN of the first embodiment described above.

The path transistor 130 sets a path for transferring charges accumulated in the photodiode PD to the floating diffusion FD2. The path transistor 130 is connected between the cathode of the photodiode PD and the floating diffusion FD2. A path setting signal PSG is applied to the gate of the path transistor 130.

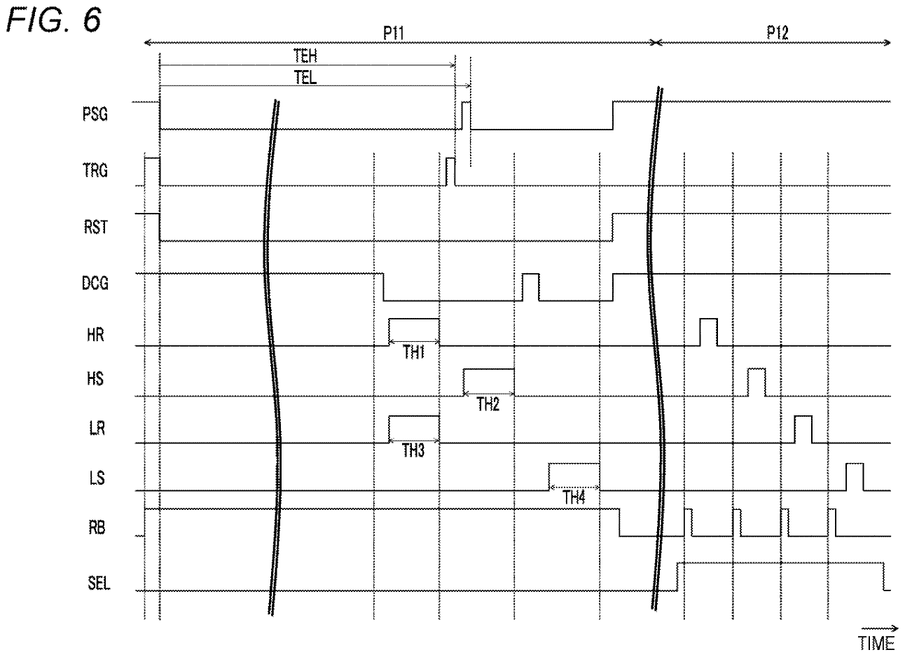

FIG. 6 is a timing chart indicating an exemplary waveform of each part during read from a pixel according to the second embodiment.

In FIG. 4, in the first embodiment described above, in the reading of the D-phase LCG level, the transfer signal TRG rises after the sample-and-hold signal HS falls, and the charges accumulated in the photodiode PD are transferred to the floating diffusions FD1 and FD2.

On the other hand, in FIG. 6, before the sample-and-hold signal HS rises, the path setting signal PSG rises, and the charges accumulated in the photodiode PD are transferred to the floating diffusion FD2. Therefore, the difference between the exposure time TEH at the D-phase HCG level and the exposure time TEL at the D-phase LCG level becomes small. The other waveforms at the time of reading from the pixel PX2 of the second embodiment are similar to the waveforms at the time of reading from the pixel PX of the first embodiment.

As described above, in the second embodiment described above, the sample-and-hold circuits SH1 and SH2 are provided for the floating diffusions FD1 and FD2 of the pixel PX, the amplification transistors AP1 and AP2 are provided for the sample-and-hold circuits SH1 and SH2, and the path transistor 130 that transfers the charges accumulated in the photodiode PD to the floating diffusion FD2 is provided. Therefore, the dark current component included in the D-phase LCG level can be canceled on the basis of the P-phase LCG level, and the SNR step between the D-phase HCG level and the D-phase LCG level can be eliminated while suppressing the decrease in the gain difference between the D-phase HCG level and the D-phase LCG level.

Furthermore, the charges accumulated in the photodiode PD can be transferred to the floating diffusion FD2 via the path transistor 130 without interposing the floating diffusion FD1. Therefore, the difference between the exposure time TEH at the D-phase HCG level and the exposure time TEL at the D-phase LCG level can be set without depending on the charging time TH2 of the sample-and-hold capacitor C2, and the difference between the exposure time TEH at the D-phase HCG level and the exposure time TEL at the D-phase LCG level can be reduced.

### 3. Third Embodiment

In the first embodiment described above, the sample-and-hold circuits SH1 and SH2 have been provided for the floating diffusions FD1 and FD2 of the pixel PX, and the amplification transistors AP1 and AP2 have been provided for the sample-and-hold circuits SH1 and SH2. In the third embodiment, a sample-and-hold circuit is provided for two floating diffusions provided in a pixel, and one floating diffusion is shared by the two sample-and-hold circuits.

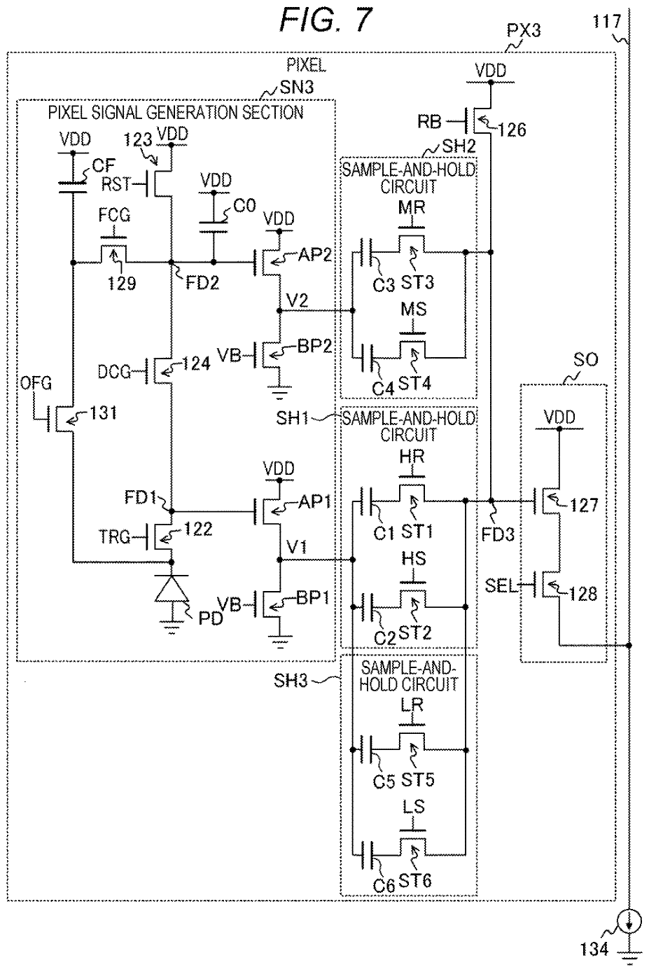

FIG. 7 is a diagram illustrating a circuit configuration example of the pixel provided in the solid-state imaging device according to the third embodiment.

In the drawing, the pixel PX3 includes a pixel signal generation section SN3 instead of the pixel signal generation section SN of the first embodiment described above. Furthermore, in the pixel PX3, the sample-and-hold circuit SH3 is added to the pixel PX of the first embodiment described above. The other configurations of the pixel PX3 are similar to the configurations of the pixel PX of the first embodiment described above.

In the pixel signal generation section SN3, a path transistor 129, an overflow control transistor 131, and an overflow capacitor CF are added to the pixel signal generation section SN of the above-described first embodiment. The other configurations of the pixel signal generation section SN3 are similar to the configurations of the pixel signal generation section SN of the first embodiment described above.

The overflow control transistor 131 controls overflow of charges from the photodiode PD to the overflow capacitor CF. The overflow control transistor 131 is connected between the cathode of the photodiode PD and the overflow capacitor CF. An overflow control signal OFG is applied to the gate of the overflow control transistor 131.

The path transistor 129 sets a path through which the charges accumulated in the overflow capacitor CF are transferred to the floating diffusion FD2. The path transistor 129 is connected between the overflow Capacitor CF and the floating diffusion FD2. A path setting signal FCG is applied to the gate of the path transistor 129.

The overflow capacitor CF accumulates the charges overflowing from the photodiode PD. The overflow capacitor CF is connected to the cathode of the photodiode PD via the overflow control transistor 131.

The overflow capacitor CF may be a metal insulation metal (MIM) capacitor, a metal oxide semiconductor (MOS) capacitor, or a metal oxide metal (MOM) capacitor. The overflow capacitor CF may be a LOFIC.

The sample-and-hold circuit SH3 samples and holds the pixel signal output from the amplification transistor AP1. At this time, the sample-and-hold circuit SH3 can sample and hold the pixel signal on the basis of the global shutter operation. The sample-and-hold circuit SH3 includes sample-and-hold capacitors C5 and C6 and sample-and-hold transistors ST5 and ST6. The sample-and-hold capacitor C5 samples and holds the P-phase level output from the amplification transistor AP1. The sample-and-hold capacitor C6 samples and holds the D-phase level output from the amplification transistor AP1. The sample-and-hold transistor ST5 sets the sampling timing of the P-phase level output from the amplification transistor AP1. The sample-and-hold transistor ST6 sets the sampling timing of the D-phase level output from the amplification transistor AP1.

The sample-and-hold circuit SH3 is connected between the source of the amplification transistor AP1 and the floating diffusion FD3. The sample-and-hold capacitor C5 and the sample-and-hold transistor ST5 are connected in series to each other. The sample-and-hold capacitor C6 and the sample-and-hold transistor ST6 are connected in series to each other. These series circuits are connected in parallel between the source of the amplification transistor AP1 and the floating diffusion FD3.

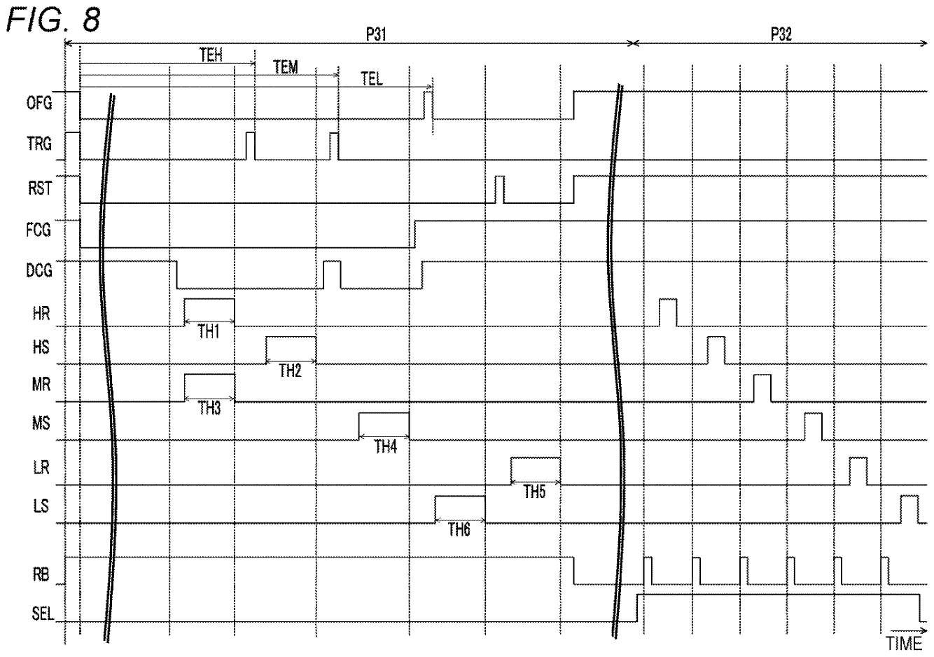

FIG. 8 is a timing chart indicating an exemplary waveform of each part during read from a pixel according to the third embodiment.

In the drawing, in reading the pixel signal from the pixel PX3, a global shutter operation period P31 and a rolling shutter operation period P32 are provided for each frame. In the global shutter operation period P31, the P-phase HCG level and the D-phase HCG level of all the pixels PX3 of the pixel array section 111 are sampled and held in the sample-and-hold capacitors C1 and C2, respectively, on the basis of the global shutter operation. Furthermore, in the global shutter operation period P31, the P-phase MCG level and the D-phase MCG level of all the pixels PX3 of the pixel array section 111 are sampled and held in the sample-and-hold capacitors C3 and C4, respectively, on the basis of the global shutter operation. At this time, the sample and hold of the P-phase HCG level and the P-phase MCG level of all the pixels PX3 of the pixel array section 111 can be performed simultaneously. Furthermore, in the global shutter operation period P31, the P-phase LCG level and the D-phase LCG level of all the pixels PX3 of the pixel array section 111 are sampled and held in the sample-and-hold capacitors C5 and C6, respectively, on the basis of the global shutter operation.

In the rolling shutter operation period P32, the P-phase HCG level and the D-phase HCG level sampled and held in the sample-and-hold capacitors C1 and C2, respectively, are read through the vertical signal line 117 for each row on the basis of the rolling shutter operation. Then, in the column ADC section 114A, the P-phase HCG level and the D-phase HCG level are each AD-converted, and CDS processing is performed. Furthermore, in the rolling shutter operation period P32, the P-phase MCG level and the D-phase MCG level sampled and held in the sample-and-hold capacitors C3 and C4, respectively, are read through the vertical signal line 117 for each row on the basis of the rolling shutter operation. Then, in the column ADC section 114A, the P-phase MCG level and the D-phase MCG level are each AD-converted, and CDS processing is performed. Furthermore, in the rolling shutter operation period P32, the P-phase LCG level and the D-phase LCG level sampled and held in the sample-and-hold capacitors C5 and C6, respectively, are read through the vertical signal line 117 for each row on the basis of the rolling shutter operation. Then, the column ADC section 114A performs AD conversion on each of the P-phase LCG level and the D-phase LCG level, and performs double data sampling (DDS) processing.

Specifically, in the global shutter operation period P31, the transfer signal TRG, the switching signal DCG, the reset signal RST, the overflow control signal OFG, and the path setting signal FCG rise before exposure starts. At this time, the transfer transistors 122, the reset transistor 123, the switching transistor 124, the overflow control transistor 131, and the path transistor 129 of all the pixels PX are turned on, and the charges of the photodiodes PD, the floating diffusions FD1 and FD2, and the overflow capacitors CF are discharged.

Furthermore, the reset signal RB rises, and the reset transistor 126 is turned on. At this time, the floating diffusion FD3 is connected to the power supply potential VDD via the reset transistor 126. Then, the transfer signal TRG, the reset signal RST, the overflow control signal OFG, and the path setting signal FCG fall. At this time, the transfer transistor 122, the reset transistor 123, the overflow control transistor 131, and the path transistor 129 are turned off, and the exposure period is started.

Next, the switching signal DCG falls, and the switching transistor 124 is turned off. At this time, the floating diffusions FD1 and FD2 are separated from each other, and the source potentials V1 and V2 of the amplification transistors AP1 and AP2 change according to the potentials of the floating diffusions FD1 and FD2, respectively. Thereafter, the sample-and-hold signals HR and MR rise, and the sample-and-hold transistors ST1 and ST3 are turned on. At this time, charges corresponding to the source potentials V1 and V2 of the amplification transistors AP1 and AP2 are accumulated in the sample-and-hold capacitors C1 and C3, respectively. Here, the P-phase HCG level is held in the sample-and-hold capacitor C1, and the P-phase MCG level is held in the sample-and-hold capacitor C3. Then, the sample-and-hold signals HR and MR fall, and the sample-and-hold transistors ST1 and ST3 are turned off. At this time, the charging times of the sample-and-hold capacitors C1 and C3 are set to TH1 and TH3. The charging times TH1 and TH3 of the sample-and-hold capacitors C1 and C3 may be different from each other. Here, the minimum exposure time can be set to a larger one of the charging times TH1 and TH3.

Next, the transfer signal TRG rises, and the transfer transistors 122 of all the pixels PX are turned on. At this time, charges that are accumulated in the photodiode PD are transferred to the floating diffusion FD1. Then, the transfer signal TRG falls, and the transfer transistors 122 of all the pixels PX are turned off. At this time, the exposure time at the D-phase HCG level is set to TEH.

Next, the sample-and-hold signal HS rises, and the sample-and-hold transistor ST2 is turned on. At this time, charges corresponding to the source potential V1 of the amplification transistor AP1 are accumulated in the sample-and-hold capacitor C2. Here, the D-phase HCG level is held in the sample-and-hold capacitor C2. Then, the sample-and-hold signal HS falls, and the sample-and-hold transistor ST2 is turned off. At this time, the charging time of the sample-and-hold capacitor C2 is set to TH2.

Next, the switching signal DCG rises, and the switching transistor 124 is turned on. At this time, the floating diffusions FD1 and FD2 are connected to each other.

Then, the transfer signal TRG rises, and the transfer transistors 122 of all the pixels PX are turned on. At this time, charges that are accumulated in the photodiode PD are transferred to the floating diffusions FD1 and FD2. Then, the transfer signal TRG falls, and the transfer transistors 122 of all the pixels PX are turned off. At this time, the exposure time at the D-phase MCG level is set to TEM.

Next, the switching signal DCG falls, and the switching transistor 124 is turned off. At this time, the floating diffusions FD1 and FD2 are separated from each other, and the source potentials V1 and V2 of the amplification transistors AP1 and AP2 change according to the potentials of the floating diffusions FD1 and FD2, respectively.

Next, the sample-and-hold signal MS rises, and the sample-and-hold transistor ST4 is turned on. At this time, charges corresponding to the source potential V2 of the amplification transistor AP2 are accumulated in the sample-and-hold capacitor C4. Here, the D-phase MCG level is held in the sample-and-hold capacitor C4. Then, the sample-and-hold signal MS falls, and the sample-and-hold transistor ST4 is turned off. At this time, the charging time of the sample-and-hold capacitor C4 is set to TH4.

Next, the switching signal DCG and the path setting signal FCG rise. At this time, the switching transistors 124 and the path transistors 129 of all the pixels PX are turned on, and the floating diffusions FD1 and FD2 and the overflow capacitors CF are connected to each other. At this time, the charges accumulated in the overflow capacitor CF are transferred to the floating diffusions FD1 and FD2. Moreover, the overflow control signal OFG rises, and the overflow control transistor 131 is turned on. At this time, charges that are accumulated in the photodiode PD are transferred to the floating diffusions FD1 and FD2. Thereafter, the overflow control signal OFG falls, and the overflow control transistor 131 is turned off. At this time, the exposure time of the D-phase LCG level is set to TEL.

Here, the source potentials V1 and V2 of the amplification transistors AP1 and AP2 change according to the potentials of the floating diffusions FD1 and FD2, respectively. Thereafter, the sample-and-hold signal LS rises, and the sample-and-hold transistor ST6 is turned on. At this time, charges corresponding to the source potential V1 of the amplification transistor AP1 are accumulated in the sample-and-hold capacitor C6. Here, the D-phase LCG level is held in the sample-and-hold capacitor C6. Then, the sample-and-hold signal LS falls, and the sample-and-hold transistor ST6 is turned off. At this time, the charging time of the sample-and-hold capacitor C6 is set to TH6.

Next, the reset signal RST rises. At this time, the reset transistor 123 of all the pixels PX is turned on, and the charges of the floating diffusions FD1 and FD2 are discharged. Then, the reset signal RB falls, and the reset transistor 126 is turned off.

Here, the source potentials V1 and V2 of the amplification transistors AP1 and AP2 change according to the potentials of the floating diffusions FD1 and FD2, respectively. Thereafter, the sample-and-hold signal LR rises, and the sample-and-hold transistor ST5 is turned on. At this time, charges corresponding to the source potential V1 of the amplification transistor AP1 are accumulated in the sample-and-hold capacitor C5. Here, the P-phase LCG level is held in the sample-and-hold capacitor C5. Then, the sample-and-hold signal LR falls, and the sample-and-hold transistor ST5 is turned off. At this time, the charging time of the sample-and-hold capacitor C5 is set to TH5.

Next, the overflow control signal OFG and the reset signal RST rise. At this time, the overflow control transistors 131 and the reset transistors 123 of all the pixels PX are turned on, and the charges of the floating diffusions FD1 and FD2 are discharged. Then, the reset signal RB falls, and the reset transistor 126 is turned off.

Next, in the rolling shutter operation period P32, the selection signal SEL rises. At this time, the selection transistor 128 is turned on, and the amplification transistor 127 is connected to the vertical signal line 117.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal HR rises, and the sample-and-hold transistor ST1 is turned on. At this time, the charges accumulated in the sample-and-hold capacitor C1 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the P-phase HCG level is read for each row on the basis of the source follower operation with the current source 134.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal HS rises, and the sample-and-hold transistor ST2 is turned on. At this time, the charges accumulated in the sample-and-hold capacitor C2 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the D-phase HCG level is read for each row on the basis of the source follower operation with the current source 134. At this time, by performing the CDS processing on the basis of the P-phase HCG level and the D-phase HCG level, the dark current component included in the D-phase HCG level can be canceled, and the SNR of the D-phase HCG level can be improved.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal MR rises, and the sample-and-hold transistor ST3 is turned on. At this time, the charges accumulated in the sample-and-hold capacitor C3 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the P-phase MCG level is read for each row on the basis of the source follower operation with the current source 134.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal MS rises, and the sample-and-hold transistor ST4 is turned on. At this time, the charges accumulated in the sample-and-hold capacitor C4 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the D-phase MCG level is read for each row on the basis of the source follower operation with the current source 134. At this time, by performing the CDS processing on the basis of the P-phase MCG level and the D-phase MCG level, the dark current component included in the D-phase MCG level can be canceled, and the SNR of the D-phase MCG level can be improved.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal LR rises, and the sample-and-hold transistor ST5 is turned on. At this time, the charges accumulated in the sample-and-hold capacitor C5 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the P-phase LCG level is read for each row on the basis of the source follower operation with the current source 134.

Next, the reset signal RB rises, and the reset transistor 126 is turned on. At this time, the charges of the floating diffusion FD3 are discharged. Then, the reset signal RB falls, and the reset transistor 126 is turned off. Thereafter, the sample-and-hold signal LS rises, and the sample-and-hold transistor ST6 is turned on. At this time, the charges accumulated in the sample-and-hold capacitor C6 are transferred to the floating diffusion FD3. Then, the source potential of the amplification transistor 127 changes according to the potential of the floating diffusion FD3 at that time. Then, the source potential of the amplification transistor 127 is applied to the vertical signal line 117 via the selection transistor 128, and the D-phase LCG level is read for each row on the basis of the source follower operation with the current source 134.

As described above, in the third embodiment, the sample-and-hold circuits SH1 and SH2 are provided for the floating diffusions FD1 and FD2 of the pixel PX3, and the sample-and-hold circuit SH3 that shares the floating diffusion FD1 with the sample-and-hold circuit SH1 is provided. Therefore, it is possible to cancel the dark current component included in the D-phase MCG level on the basis of the P-phase MCG level while enabling switching of the conversion efficiency in three stages.

Therefore, it is possible to eliminate the SNR step between the D-phase HCG level and the D-phase MCG level while suppressing the decrease in the gain difference between the D-phase HCG level and the D-phase MCG level, and to further expand the dynamic range.

Furthermore, it is possible to simultaneously hold samples of the P-phase HCG level and the P-phase MCG level. Therefore, the number of sample-and-holds performed in time series in accordance with the switching of the conversion efficiency at the time of the global shutter operation can be reduced from six to five, and a decrease in the frame rate in HDR can be suppressed.

Note that the path transistor 130 of the second embodiment described above may be provided in the pixel PX3. At this time, the path transistor 130 is connected between the cathode of the photodiode PD of the pixel PX3 and the floating diffusion FD2.

### 4. Fourth Embodiment

In the first embodiment described above, in each of the sample-and-hold circuits SH1 and SH2, two series circuits of the sample-and-hold capacitor and the sample-and-hold transistor are connected in parallel between the source of each of the amplification transistors AP1 and AP2 and the floating diffusion FD3. In the fourth embodiment, in the sample-and-hold circuit, two series circuits of a sample-and-hold capacitor and a sample-and-hold transistor are connected in parallel between the floating diffusion FD3 and the ground potential.

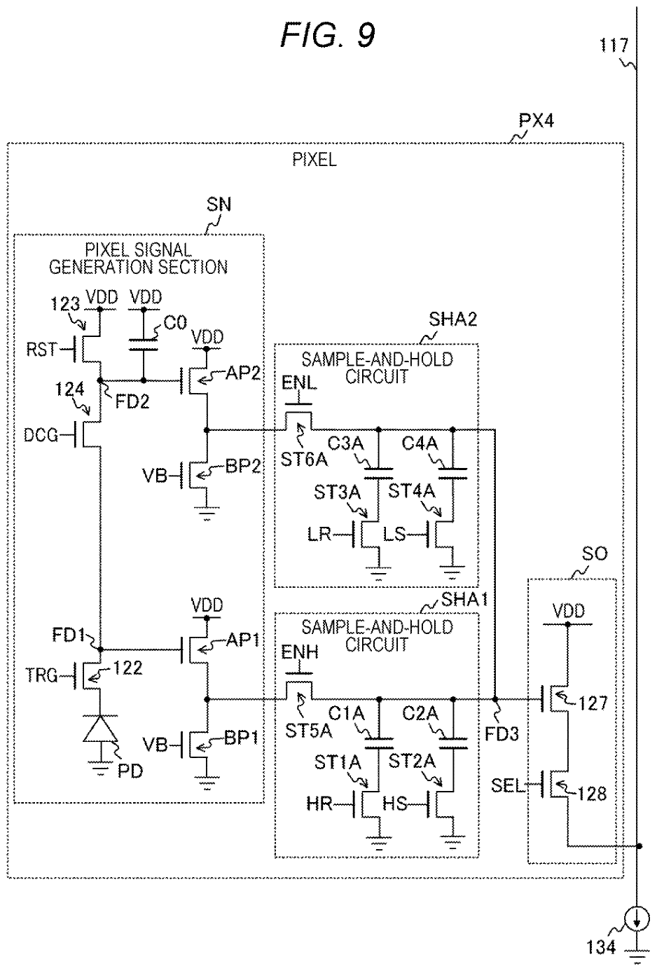

FIG. 9 is a diagram illustrating a circuit configuration example of the pixel provided in a solid-state imaging device according to the fourth embodiment.

In the drawing, the pixel PX4 includes sample-and-hold circuits SHA1 and SHA2 instead of the sample-and-hold circuits SH1 and SH2 of the first embodiment described above. The other configurations of the pixel PX4 are similar to the configurations of the pixel PX of the first embodiment described above.

The sample-and-hold circuit SHA1 samples and holds the pixel signal output from the amplification transistor AP1. At this time, the sample-and-hold circuit SHA1 can sample and hold the pixel signal on the basis of the global shutter operation. The sample-and-hold circuit SHA1 includes sample-and-hold capacitors C1A and C2A and sample-and-hold transistors ST1A, ST2A, and ST5A.

The sample-and-hold capacitor C1A samples and holds the P-phase level output from the amplification transistor AP1. The sample-and-hold capacitor C2A samples and holds the D-phase level output from the amplification transistor AP1. The sample-and-hold transistor ST1A sets the sampling timing of the P-phase level output from the amplification transistor AP1. The sample-and-hold transistor ST2A sets the sampling timing of the D-phase level output from the amplification transistor AP1. The sample-and-hold transistor ST5A switches connection between the sample-and-hold circuit SHA1 and the amplification transistor AP1.

The sample-and-hold circuit SHA1 is connected between the source of the amplification transistor AP1 and the floating diffusion FD3. The sample-and-hold capacitor C1A and the sample-and-hold transistor ST1A are connected in series. The sample-and-hold capacitor C2A and the sample-and-hold transistor ST2A are connected in series. These series circuits are connected in parallel between the ground potential and the floating diffusion FD3.

These series circuits may be connected in parallel between the power supply potential VDD and the floating diffusion FD3. The sample-and-hold transistor ST5A is connected between the source of the amplification transistor AP1 and the floating diffusion FD3.

The sample-and-hold signal HR is applied to the gate of the sample-and-hold transistor ST1A. A sample-and-hold signal HS is applied to the gate of the sample-and-hold transistor ST2A. A sample-and-hold signal ENH is applied to the sample-and-hold transistor ST5A.

The sample-and-hold circuit SHA2 samples and holds the pixel signal output from the amplification transistor AP2. At this time, the sample-and-hold circuit SHA2 can sample and hold the pixel signal on the basis of the global shutter operation. The sample-and-hold circuit SHA2 includes sample-and-hold capacitors C3A and C4A and sample-and-hold transistors ST3A, ST4A, and ST6A.

The sample-and-hold capacitor C3A samples and holds the P-phase level output from the amplification transistor AP2. The sample-and-hold capacitor C4A samples and holds the D-phase level output from the amplification transistor AP2. The sample-and-hold transistor ST3A sets the sampling timing of the P-phase level output from the amplification transistor AP2. The sample-and-hold transistor ST4A sets the sampling timing of the D-phase level output from the amplification transistor AP2. The sample-and-hold transistor ST6A switches connection between the sample-and-hold circuit SHA2 and the amplification transistor AP2.

The sample-and-hold circuit SHA2 is connected between the source of the amplification transistor AP2 and the floating diffusion FD3. The sample-and-hold capacitor C3A and the sample-and-hold transistor ST3A are connected in series. The sample-and-hold capacitor C4A and the sample-and-hold transistor ST4A are connected in series. These series circuits are connected in parallel between the ground potential and the floating diffusion FD3.

These series circuits may be connected in parallel between the power supply potential VDD and the floating diffusion FD3. The sample-and-hold transistor ST6A is connected between the source of the amplification transistor AP2 and the floating diffusion FD3.

The sample-and-hold signal LR is applied to the gate of the sample-and-hold transistor ST3A. A sample-and-hold signal LS is applied to the gate of the sample-and-hold transistor ST4A. A sample-and-hold signal ENL is applied to the sample-and-hold transistor ST6A.

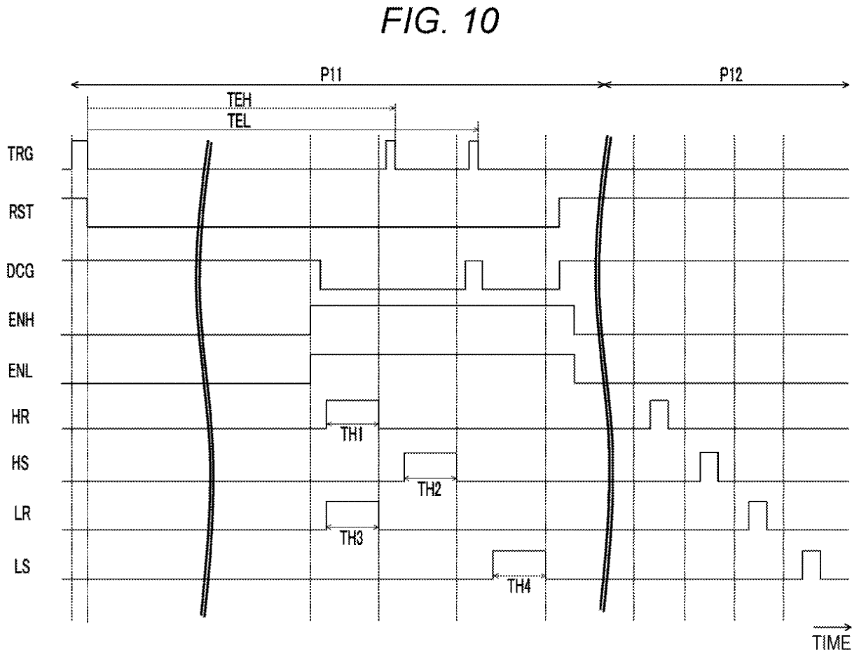

FIG. 10 is a timing chart indicating an exemplary waveform of each part during read from a pixel according to the fourth embodiment.

In the drawing, the sample-and-hold transistors ST1A to ST4A and the sample-and-hold capacitors C1A to C4A operate similarly to the sample-and-hold transistors ST1 to ST4 and the sample-and-hold capacitors C1 to C4 of the first embodiment described above on the basis of the sample-and-hold signals HR, HS, LR, and LS.

Furthermore, before the sample-and-hold signals HR and LR rise, the sample-and-hold signals ENH and ENL rise, and the sample-and-hold transistors ST5A and ST6A are turned on.

Moreover, after the sample-and-hold signal LS falls, the sample-and-hold signals ENH and ENL fall, and the sample-and-hold transistors ST5A and ST6A are turned off. The other waveforms at the time of reading from the pixel PX4 of the fourth embodiment are similar to the waveforms at the time of reading from the pixel PX of the first embodiment.

As described above, in the above-described fourth embodiment, the sample-and-hold circuits SHA1 and SHA2 are provided for the floating diffusions FD1 and FD2 of the pixel PX4, and the amplification transistors AP1 and AP2 are provided for the sample-and-hold circuits SHA1 and SHA2. Therefore, the dark current component included in the D-phase LCG level can be canceled on the basis of the P-phase LCG level, and the SNR step between the D-phase HCG level and the D-phase LCG level can be eliminated while suppressing the decrease in the gain difference between the D-phase HCG level and the D-phase LCG level.

Note that the path transistor 130 of the second embodiment described above may be provided in the pixel PX4. At this time, the path transistor 130 is connected between the cathode of the photodiode PD of the pixel PX4 and the floating diffusion FD2.

Furthermore, in the third embodiment described above, three sample-and-hold circuits similar to the configuration of the sample-and-hold circuit SHA1 ay be provided instead of the sample-and-hold circuits SH1 to SH3 of the first embodiment described above.

### 5. Fifth Embodiment

In the first embodiment described above, the sample-and-hold circuits SH1 and SH2 have been provided for the floating diffusions FD1 and FD2 of the pixel PX, and the amplification transistors AP1 and AP2 have been provided for the sample-and-hold circuits SH1 and SH2. In a fifth embodiment, a semiconductor chip provided with a pixel array section with pixels arranged in a matrix is stacked.

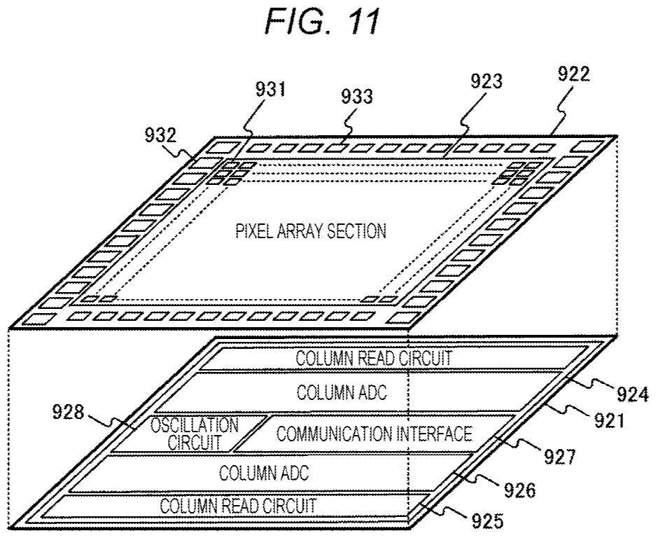

FIG. 11 is a perspective view illustrating an example of stacking of a pixel array section according to the fifth embodiment.

In the figure, a solid-state imaging device includes semiconductor chips 921 and 922. The semiconductor chip 922 is stacked on the semiconductor chip 921.

A pixel array section 923 is formed on the semiconductor chip 922. The pixel array section 923 includes pixels 931 arranged in a matrix in the row direction and the column direction. The pixel 931 may be any of the pixels PX, PX2, PX3, and PX4 of the first to fourth embodiments described above. Pad electrodes 932 and via electrodes 933 are formed around the pixel array section 923. The via electrodes 933 penetrate the semiconductor chip 922 and can electrically connect the semiconductor chips 921 and 922 to each other.

A peripheral circuit 924 is formed on the semiconductor chip 921. On the peripheral circuit 924, a column read circuit 925, a column ADC 926, a communication interface 927, and an oscillation circuit 928 are formed. The column read circuit 925 and the column ADC 926 may be formed so as to correspond to positions on both sides of the pixel array section 923 in the column direction.

The semiconductor chips 921 and 922 may be directly bonded. For the direct bonding of the semiconductor chips 921 and 922, hybrid bonding can be used. At this time, the semiconductor chips 921 and 922 may be electrically connected to each other on the basis of Cu—Cu connection. The material of semiconductor substrates used for the semiconductor chips 921 and 922 may be Si, InGaAs, or InP.

In such a manner, in the above-described fifth embodiment, the semiconductor chip 922 with the pixel array section 923 formed thereon is stacked on the semiconductor chip 921 with the peripheral circuit 924 formed thereon. Therefore, with this arrangement, the dynamic range of the solid-state imaging device can be increased while suppressing an increase in mounting area of the semiconductor chip on which the solid-state imaging device is formed.

### 6. Application Example to Mobile Body

The technology (the present technology) according to the present disclosure can be applied to various products.

For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

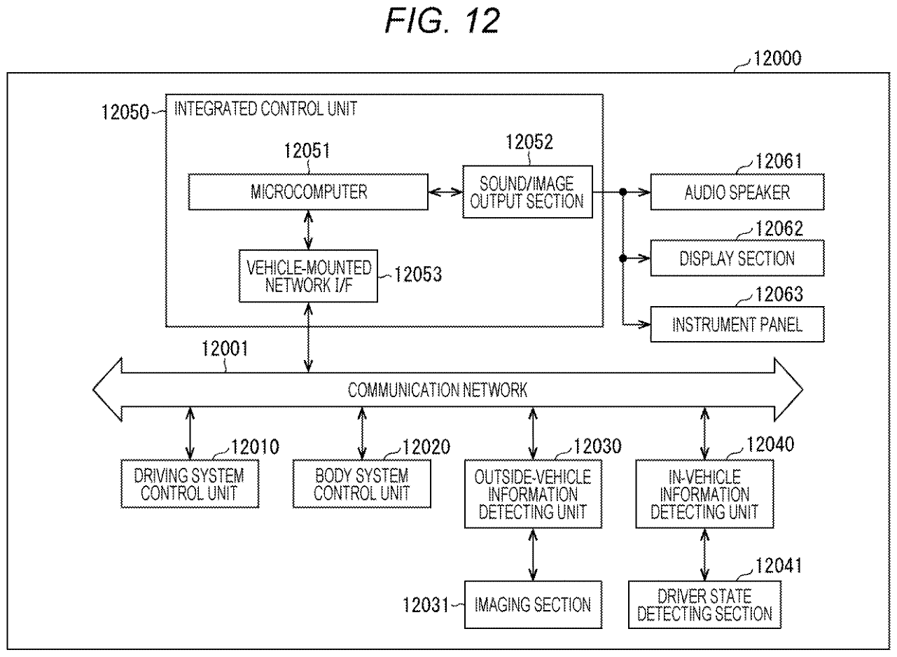

FIG. 12 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 12, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs.

For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle. The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 12, as the output device, an audio speaker 12061, a display section 12062, and an instrument panel 12063 are illustrated. The display section 12062 may, for example, include at least one of an on-board display and a head-up display.

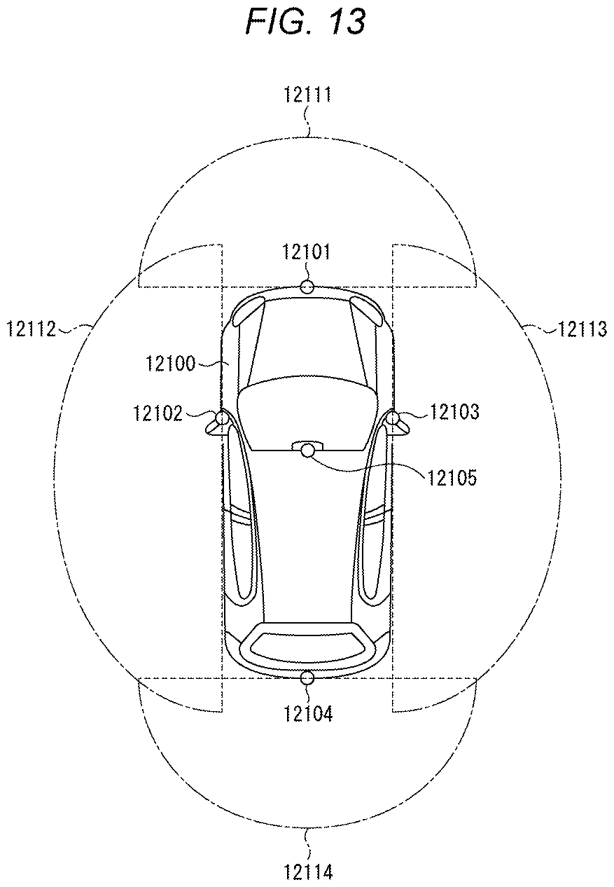

FIG. 13 is a diagram illustrating an example of installation positions of the imaging section 12031. In FIG. 13, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like. Note that FIG. 13 illustrates an example of imaging ranges of the imaging sections 12101 to 12104. An imaging range 12111 represents the imaging range of the imaging section 12101 provided to the front nose.

Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object.

When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology of the present disclosure can be applied to the imaging section 12031 among the components described above.

Specifically, for example, each imaging device in the above-described embodiment is applicable to the imaging section 12031. By applying the technology according to the present disclosure to the vehicle control system 12000, it is possible to expand a dynamic range while suppressing deterioration in image quality at the time of global shutter operation.

Furthermore, the embodiments described above show examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. The present technology, however, is not limited to the embodiments, and can be implemented by making various modifications to the embodiments without departing from the scope of the present technology.

Furthermore, effects described in the present specification are merely examples and not limited, and other effects may be provided.

Note that the present technology may also have the following configurations.
(1) An imaging device including:
a plurality of floating diffusions provided in a pixel; and
a plurality of sample-and-hold circuits capable of sampling and holding a signal for each of the plurality of floating diffusions.
(2) The imaging device according to (1), in which the pixel includes
a photoelectric conversion section,
a first floating diffusion to which charges photoelectrically converted by the photoelectric conversion section are transferred,
a second floating diffusion separated from the first floating diffusion,
a switching transistor that switches connection between the first floating diffusion and the second floating diffusion,
a first amplification transistor that is driven on a basis of a potential of the first floating diffusion,
a second amplification transistor that is driven on a basis of a potential of the second floating diffusion,
a first sample-and-hold circuit that samples and holds an output of the first amplification transistor, and a second sample-and-hold circuit that samples and holds an output of the second amplification transistor.
(3) The imaging device according to (2), in which the first sample-and-hold circuit includes
a first sample-and-hold capacitor that holds charges corresponding to a P-phase high conversion gain (HCG) level,
a second sample-and-hold capacitor that holds charges corresponding to a D-phase HCG level,
a first sample-and-hold transistor that sets a sampling timing of the P-phase HCG level, and
a second sample-and-hold transistor that sets a sampling timing of the D-phase HCG level, and
the second sample-and-hold circuit includes
a third sample-and-hold capacitor that holds charges corresponding to a P-phase low conversion gain (LCG) level,
a fourth sample-and-hold capacitor that holds charges corresponding to the D-phase LCG level,
a third sample-and-hold transistor that sets a sampling timing of the P-phase LCG level, and
a fourth sample-and-hold transistor that sets the sampling timing of the D-phase LCG level.
(4) The imaging device according to (3), in which a sample-and-hold timing at the P-phase HCG level of the first sample-and-hold capacitor and a sample-and-hold timing at the P-phase LCG level of the third sample-and-hold capacitor are equal to each other.
(5) The imaging device according to (3) or (4), further including:
a path transistor that is connected between the photoelectric conversion section and the second floating diffusion and sets a path of charges from the photoelectric conversion section.
(6) The imaging device according to (5), in which the path transistor is turned on while the second sample-and-hold transistor is turned on in a global shutter operation period.
(7) The imaging device according to any one of (2) to (6), further including:
an overflow capacitor that accumulates charges having overflowed from the photoelectric conversion section.
(8) The imaging device according to (7), further including:
a third sample-and-hold circuit that samples and holds an output of the first amplification transistor.
(9) The imaging device according to (8), in which the first sample-and-hold circuit includes
a first sample-and-hold capacitor that holds charges corresponding to a P-phase HCG level,
a second sample-and-hold capacitor that holds charges corresponding to the D-phase HCG level,
a first sample-and-hold transistor that sets a sampling timing of the P-phase HCG level, and
a second sample-and-hold transistor that sets a sampling timing of the D-phase HCG level,
the second sample-and-hold circuit includes
a third sample-and-hold capacitor that holds charges corresponding to a P-phase middle conversion gain (MCG) level,
a fourth sample-and-hold capacitor that holds charges corresponding to the D-phase MCG level,
a third sample-and-hold transistor that sets a sampling timing of the P-phase MCG level, and
a fourth sample-and-hold transistor that sets a sampling timing of the D-phase MCG level, and
the third sample-and-hold circuit includes
a fifth sample-and-hold capacitor that holds charges corresponding to a P-phase LCG level,
a sixth sample-and-hold capacitor that holds charges corresponding to the D-phase LCG level,
a fifth sample-and-hold transistor that sets a sampling timing of the P-phase LCG level, and
a sixth sample-and-hold transistor that sets the sampling timing of the D-phase LCG level.
(10) The imaging device according to (9), in which a sample-and-hold timing at the P-phase HCG level of the first sample-and-hold capacitor and a sample-and-hold timing at the P-phase MCG level of the third sample-and-hold capacitor are equal to each other.
(11) The imaging device according to any one of (1) to (10), further including:
a pixel array section in which the pixels are arranged in a matrix in a row direction and a column direction;
a read circuit that reads out a pixel signal sampled and held in the pixel in the column direction; and
an AD conversion section that performs AD conversion on the pixel signal read by the read circuit.

### REFERENCE SIGNS LIST

100 Imaging device
101 Optical system
102 Solid-state imaging device
103 Imaging control section
104 Image processing section
105 Storage section
106 Display section
107 Operation section
108 Bus
111 Pixel array section
112 Vertical scanning circuit
113 Column read circuit
114 Column signal processing section
115 Horizontal scanning circuit
116 Control circuit
117 Vertical signal line
118 Horizontal drive line
PX Pixel
PD Photodiode
FD1 to FD3 Floating diffusion
122 Transfer transistor
123, 126 Reset transistor
124 Switching transistor
AP1, AP2, 127 Amplification transistor
BP1, BP2 Current source transistor
128 Selection transistor
SH1, SH2 Sample-and-hold circuit
C1 to C4 Sample-and-hold capacitor
ST1 to ST4 Sample-and-hold transistor
134 Current source

1. An imaging device comprising:
a plurality of floating diffusions provided in a pixel; and
a plurality of sample-and-hold circuits capable of sampling and holding a signal for each of the plurality of floating diffusions.

2. The imaging device according to claim 1, wherein
the pixel includes
a photoelectric conversion section,
a first floating diffusion to which charges photoelectrically converted by the photoelectric conversion section are transferred,
a second floating diffusion separated from the first floating diffusion,
a switching transistor that switches connection between the first floating diffusion and the second floating diffusion,
a first amplification transistor that is driven on a basis of a potential of the first floating diffusion,
a second amplification transistor that is driven on a basis of a potential of the second floating diffusion,
a first sample-and-hold circuit that samples and holds an output of the first amplification transistor, and
a second sample-and-hold circuit that samples and holds an output of the second amplification transistor.

3. The imaging device according to claim 2, wherein
the first sample-and-hold circuit includes
a first sample-and-hold capacitor that holds charges corresponding to a P-phase high conversion gain (HCG) level,
a second sample-and-hold capacitor that holds charges corresponding to a D-phase HCG level,
a first sample-and-hold transistor that sets a sampling timing of the P-phase HCG level, and
a second sample-and-hold transistor that sets a sampling timing of the D-phase HCG level, and
the second sample-and-hold circuit includes
a third sample-and-hold capacitor that holds charges corresponding to a P-phase low conversion gain (LCG) level,
a fourth sample-and-hold capacitor that holds charges corresponding to the D-phase LCG level,
a third sample-and-hold transistor that sets a sampling timing of the P-phase LCG level, and
a fourth sample-and-hold transistor that sets the sampling timing of the D-phase LCG level.

4. The imaging device according to claim 3, wherein
a sample-and-hold timing at the P-phase HCG level of the first sample-and-hold capacitor and a sample-and-hold timing at the P-phase LCG level of the third sample-and-hold capacitor are equal to each other.

5. The imaging device according to claim 3, further comprising:
a path transistor that is connected between the photoelectric conversion section and the second floating diffusion and sets a path of charges from the photoelectric conversion section.

6. The imaging device according to claim 5, wherein
the path transistor is turned on while the second sample-and-hold transistor is turned on in a global shutter operation period.

7. The imaging device according to claim 2, further comprising:
an overflow capacitor that accumulates charges having overflowed from the photoelectric conversion section.

8. The imaging device according to claim 7, further comprising:
a third sample-and-hold circuit that samples and holds an output of the first amplification transistor.

9. The imaging device according to claim 8, wherein
the first sample-and-hold circuit includes
a first sample-and-hold capacitor that holds charges corresponding to a P-phase HCG level,
a second sample-and-hold capacitor that holds charges corresponding to the D-phase HCG level,
a first sample-and-hold transistor that sets a sampling timing of the P-phase HCG level, and
a second sample-and-hold transistor that sets a sampling timing of the D-phase HCG level,
the second sample-and-hold circuit includes
a third sample-and-hold capacitor that holds charges corresponding to a P-phase middle conversion gain (MCG) level,
a fourth sample-and-hold capacitor that holds charges corresponding to the D-phase MCG level,
a third sample-and-hold transistor that sets a sampling timing of the P-phase MCG level, and
a fourth sample-and-hold transistor that sets a sampling timing of the D-phase MCG level, and
the third sample-and-hold circuit includes
a fifth sample-and-hold capacitor that holds charges corresponding to a P-phase LCG level,
a sixth sample-and-hold capacitor that holds charges corresponding to the D-phase LCG level,
a fifth sample-and-hold transistor that sets a sampling timing of the P-phase LCG level, and
a sixth sample-and-hold transistor that sets the sampling timing of the D-phase LCG level.

10. The imaging device according to claim 9, wherein
a sample-and-hold timing at the P-phase HCG level of the first sample-and-hold capacitor and a sample-and-hold timing at the P-phase MCG level of the third sample-and-hold capacitor are equal to each other.

11. The imaging device according to claim 1, further comprising:
a pixel array section in which the pixels are arranged in a matrix in a row direction and a column direction;
a read circuit that reads out a pixel signal sampled and held in the pixel in the column direction; and
an AD conversion section that performs AD conversion on the pixel signal read by the read circuit.
